(19) United States
(12) Patent Application Publication
(10) Pub. No.: US 2008/0111799 A1
(43) Pub. Date: May 15, 2008

(54) Driving an electroluminescent display

(75) Inventors: Jurgen Hoppenbrouwers, Eindhoven (NL); Frank Budzelaar, Eindhoven (NL); Michiel Adriaanszoon Klompenhouwer, Eindhoven (NL); Peter Van De Weijer, Eindhoven (NL); Nijs Van Der Vaart, Eindhoven (NL); Gerben Hekstra, Eindhoven (NL); Nico Cordes, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,174

(22) PCT Filed: May 11, 2005
(86) PCT No.: PCT/IB05/51534

§ 371 Date: Nov. 16, 2006

(30) Foreign Application Priority Data
May 25, 2004 (EP) 04102282.3

(51) Int. Cl. G06F 3/038

(52) U.S. Cl. 345/204

(57) ABSTRACT

A driver (DD, SD, PD1, PD2) drives a display panel which comprises a first set of light emitting elements (PL1) and a second set of light emitting elements (PL2). The driver (DD, SD, PD1, PD2) comprises a data driver (DD) which receives a first set of input image signals (R) representing a first color to supply a first set of data signals (RD 1) to the first set of light emitting elements (PL1), respectively. The data driver (DD) further receives a second set of input image signals (B) representing a second color to supply a second set of data signals (BD1) to the second set of light emitting elements (PL2), respectively. A lowpass filter (LPF) is provided to obtain the second set of data signals (BD1) having a bandwidth being smaller than a bandwidth of the first set of data signals (RD1).

### FIELD OF THE INVENTION

The invention relates to a driver for an electroluminescent display panel, a display module comprising an electroluminescent display panel and such a driver, a display apparatus comprising the display module, and a method of driving an electroluminescent display.

### BACKGROUND OF THE INVENTION

U.S. Pat. No. 6,441,560 B1 discloses an active matrix display device which comprises an array of display pixels, also referred to as pixels, each comprising an electroluminescent display element and a pixel driving circuit. The pixel driving circuit controls the current through the display element based on a drive signal which is applied to the pixel during an address period and which is stored as a voltage on a storage capacitance connected to the pixel driving circuit. Each pixel includes an electro-optic adjustment circuit which is responsive to light produced by the display element during addressing and which is arranged to adjust, in the address period, the voltage signal stored on the capacitance in accordance with the light output level of the display element. The adjustment of the voltage signal on the capacitance compensates for the effects of ageing of the display elements so that a desired light output level from a display element for a given applied drive signal is substantially maintained, regardless of possible variations in the drive current level to light output level characteristics of individual display elements in the array. Although this prior art provides a behavior of the pixels less dependent on aging, it does not increase the life time of the display.

### SUMMARY OF THE INVENTION

It is an object of the invention to provide a driver for an electroluminescent display which obtains a longer life-time of at least one set of the light emitting elements having a particular color.

A first aspect of the invention provides a driver as claimed in claim 1. A second aspect of the invention provides a display module as claimed in claim 9. A third aspect of the invention provides a display apparatus as claimed in claim 10. A fourth aspect of the invention comprises a method of driving an electroluminescent display as claimed in claim 12. Advantageous embodiments are defined in the dependent claims.

A driver in accordance with the first aspect of the invention comprises a data driver and a low-pass filter. The data driver receives a first set of input signals representing a first color to supply a first set of data signals to a first set of light emitting elements, respectively. The data driver further receives a second set of input signals representing a second, other, color to supply a second set of data signals to the second set of light emitting elements, respectively. Thus, for example, the input signals of the first set are the red input signals and the first set of data signals is supplied to red light emitting elements. And the input signals of the second set are the blue input signals, and the second set of data signals is supplied to blue light emitting elements.

A low pass filter is present to obtain a bandwidth of the second set of input signals which is smaller than the bandwidth of the first set of input signals. Thus, in the same example, the bandwidth of the data signals supplied to the blue light emitting elements is limited with respect to the bandwidth of the data signals supplied to the red light emitting elements. The effect of the low-pass filtering is that the second data has more averaged values and thus has less high peak levels than if the low-pass filtering is not present. Consequently, the currents through the second light emitting elements will be averaged and the life-time of the second light emitting element is increased. This is due to the non-linear ageing behavior of the material of the light emitting elements which causes the light emitting elements to age faster at higher currents at a same value of the multiplication of the current level with the period in time it is present.

It has to be noted that U.S. Pat. No. 6,583,775 B1 discloses an active matrix display of which the pixels comprise a light emitting element with a brightness value which depends on an amount of current supplied to the light emitting element. The light emitting elements are OLED's (organic light emitting diodes). A scanning line drive circuit selects the rows of pixels one by one, each during a row select period. A data line drive circuit supplies data signals to the selected pixels. The pixels comprise a pixel drive circuit which determines a level of the current dependent on the data received. At the start of a row select period, the light emitting elements start to emit with a brightness determined by the current. After the row select period, the light emitting elements continue emitting with this brightness, usually until after a frame period the same row of pixels is selected again and new data signals are received. It is also possible that the row of light emitting elements only produce light during a single row select period. Also in this application, due to the low-pass filtering or averaging in accordance with the invention, the peak current levels occur significantly less and the lifetime of the display will be increased.

In the embodiment in accordance with the invention as claimed in claim 2, the driver comprises a first set of pixel drivers which supply a first set of currents to the first set of light emitting elements of the display. The driver further comprises a second set of pixel drivers which supply a second set of currents to the second set of light emitting elements of the display. The first set of currents is determined by the first set of data signals and the second set of currents is determined by the second set of data signals. The low-pass filter low-pass filters the second set of input image signals to obtain a set of low-pass filtered image signals which are supplied to the data driver instead of the second set of input signals. Thus the bandwidth of the second set of input image signals has been made smaller than the bandwidth of the first set of input image signals. Consequently, the luminance values of the second set of light emitting elements are averaged and thus have lower peak values than the luminance values of the first set of light emitting elements.

In the embodiment in accordance with the invention as claimed in claim 3, the low-pass filter is a spatial low-pass filter which low-pass filters the data signal of the same set of light emitting elements of at least one adjacent pixel in the same frame period. Usually, this spatial low-pass filtering or averaging is obtained by determining a weighted sum of the data signal of the present pixel and the data signal of at least one spatially neighboring pixel. Preferably, the spatial neighboring pixel or pixels are preceding and/or succeeding pixels in the same row such that no line memories are required.

In the embodiment in accordance with the invention as claimed in claim 4, the low-pass filter is a two-dimensional filter which averages the data signals of pixels in the same row (usually extending in the horizontal direction) and in previous and/or next row(s) (usually vertically offset with respect to the present pixel). Although in this embodiment at least one line memory is required, the spatial low-pass filtering may further reduce the peak values in the current.

In the embodiment in accordance with the invention as claimed in claim 5, the low-pass filter is a temporal filter. Such a filter usually determines a weighted sum of the present data signal and the data signal at the same position of a previous frame or frames and/or a spatially neighboring data signal of a previous frame or of previous frames. The temporal filter comprises one or more frame memories to store the data signal of the previous frame or of the previous frames, respectively.

In the embodiment in accordance with the invention as claimed in claim 6, the light emitting elements are organic light emitting diodes, further referred to as OLED's. Such polymer and small molecule organic light emitting diodes have opened a new path to make high quality displays. The advantages of these displays are the self-emissive technology, the high brightness, the near-perfect viewing angle, and the fast response time. For large displays, an active matrix construction is required to reduce the power consumption, for small displays also passive matrix is possible. In present OLED displays, the lifetime of the blue OLED material is much shorter than that of the red and green OLED materials. In the embodiment in accordance with the invention as claimed in claim 7, the low-pass filtering is performed on the data signal for the blue pixels. The lower average currents through the blue OLED's results in an increased lifetime of the blue pixels. Thus, the lifetime of the blue pixels becomes more equal to the lifetime of the red and the green pixels and the lifetime of the display increases. It has been found that the low-pass filtering of only the blue data signal does not significantly deteriorate the quality of the displayed image. The human eye appears to resolve a lower resolution for blue light than for red and green light.

In an embodiment in accordance with the invention as claimed in claim 8, the first set of data signals is high frequency boosted with a high frequency boosting filter. This compensates for the resolution decrease, if present, caused by a relatively strong low-pass filtering of the second set of data signals.

These and other aspects of the invention are apparent from and will be elucidated with reference to the embodiments described hereinafter.

### BRIEF DESCRIPTION OF THE DRAWINGS

In the drawings:

FIG. 1 shows schematically a display apparatus with a display panel which comprises light emitting elements,

FIG. 2 shows an embodiment of a pixel drive circuit to generate a current through the associated light emitting element,

FIG. 3 shows the effect of the low-pass filtering of the data signal on the current through the light emitting element,

FIG. 4 shows an embodiment of the low-pass filter, and

FIG. 5 shows another embodiment of the low-pass filter.

### DETAILED DESCRIPTION OF THE PREFERRED EMBODIMENT

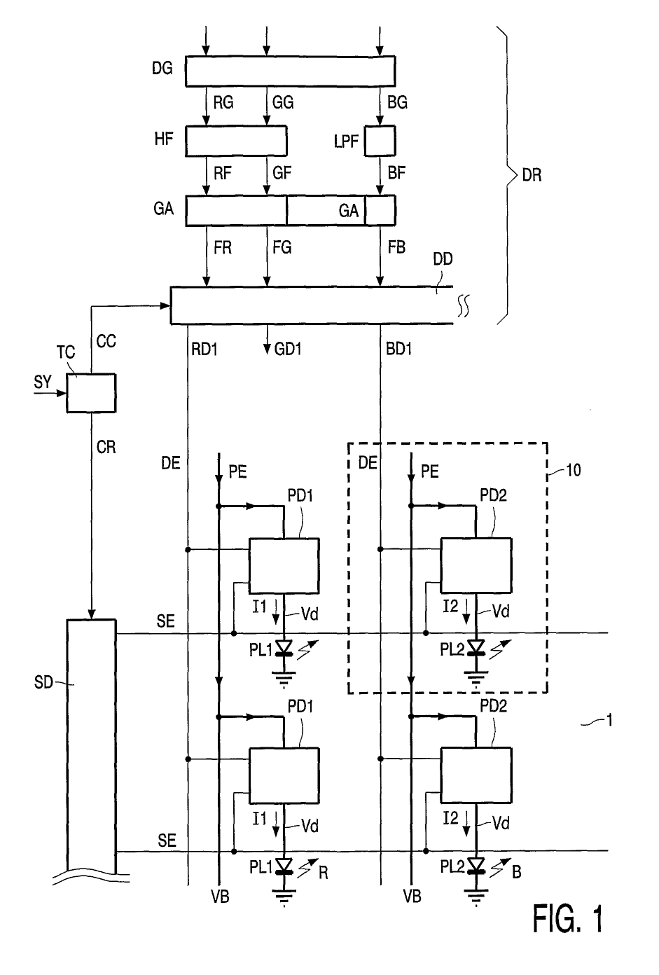

FIG. 1 shows schematically a display apparatus with a display panel which comprises light emitting elements. FIG. 1 shows only four pixels 10 of a matrix display panel 1. In a practical implementation, the matrix display panel 1 may have many more pixels 10. It is also possible that the pixels 10 are not arranged in a matrix configuration. However for the ease of elucidation, in the now following a matrix display is discussed. Each pixel 10 comprises a light emitting diode further referred to as LED PL1 or PL2 and a pixel driving circuit PD1 or PD2, respectively. The LED's PL1 and PL2 may be, for example, an inorganic electroluminescence (EL) device, a cold cathode, or an organic LED like a polymer or small molecule LED. Usually, the LED's PL1 and PL2 emit light with a different color to obtain a multicolor display. In full color displays, at least three different LED's emitting three primary colors, usually red, green and blue, are present. But, other primary colors may be used. It is also possible to group more than three LED's to obtain a full color display. For, example, a white or yellow LED may be added.

By way of example, in FIG. 1 the select electrodes SE extend in the row direction and the data electrodes DE extend in the column direction. It is also possible that the select electrodes SE extend in the column direction and that the data electrodes DE extend in the row direction. The power supply electrodes PE extend in the column direction. The power supply electrodes PE may as well extend in the row direction, or may form a grid. It is possible that a single display line has more select electrodes SE.

Each one of the pixel driving circuits PD1 receives a select signal from an associated select electrode SE, a data signal RD1 from an associated data electrode DE, a power supply voltage VB from an associated power supply electrode PE, and supplies a current I1 to its associated LED PL1. Each one of the pixel driving circuits PD2 receives a select signal from its associated select electrode SE, a data signal BD1 from its associated data electrode DE, a power supply voltage VB from its associated power supply electrode PE, and supplies a current 12 to its associated LED PL2. Although for the same groups of pixels 10 the same references are used to indicate the same elements, the value of signals, voltages and data may be different.

A select driver SD supplies the select signals to the select electrodes SE. A data driver DD receives the input image signals FR and FB to supply the data signals RD1 and BD1 to the data electrodes DE. In a full color display, the data driver may further receive the data signal FG to supply the data signal GD1 to further pixels 10 (not shown) which have another color than both the pixels which receive the data signals RD1 and BD1. In the embodiment shown in FIG. 1, it is assumed that the input image signal IV comprises the input image component signals R (red), G (green) and B (blue). An optional de-gamma circuit DG receives the input image component signals R, G, B and supplies the corrected signals RG, GG, BG, respectively. A low-pass filter LPF receives the corrected signal BG and supplies a low-pass filtered input image signal BF to an optional gamma circuit GA. An optional high-frequency boost filter HF receives the corrected signals RG and GG and supplies the high-frequency boosted signals RF and GF to the optional gamma circuit GA. The high frequency boosting may be obtained by adding the respective input signal of the high-frequency boost filter HF to its high-pass filtered input signal. This optional high-frequency boosting filter HPF increases the sharpness of the image display and may also compensate for a sharpness decrease caused by the low-pass filter. The gamma circuit GA supplies the output signals FR, FG and FB to the data driver DD.

The de-gamma circuit DG processes the input image signal IV to remove the pre-gamma correction from it. Such a pre-gamma correction is usually present and was originally intended to pre-compensate for the gamma of a cathode ray tube. Thus, the corrected signals RG, GG, BG are present in the linear light domain. Consequently, advantageously, the low-pass filtering and the high-frequency boosting filtering are performed in the linear light domain. The gamma circuit GA processes the filtered signals RF, GF, BF to add a pre-gamma correction fitting the display panel 1 used.

The low-pass filter LPF and the high frequency boost filter HF may be part of a standard video scaler which scales the input image component signals R, G, B. Also the input image component signals R, G may be low-pass filtered, but the result should be that the bandwidth of the low-pass filtered signals BF and FB is smaller than the bandwidth of the output signals RF, FR and GF, FG. The de-gamma circuit DG and the gamma circuit GA may be implemented as well known lookup tables. If the de-gamma circuit DG and the gamma circuit GA are not present, the input image component signal B is low-pass filtered and fed to the data driver DD, directly. Further, if the high frequency boosting filter HF is also not present the input image component signals R and G are fed directly to the data driver DD.

In FIG. 1, the data driver receives the output signals FR, FG and FB which represent the three primary colors. In a full color display more than three different sets of light emitting elements may be present which each are driven by a corresponding output signal. If a fall color display is not required, two output signals FR and FB may suffice. The grey level of the LED PL1 is determined by the level of the current I1 flowing through the LED PL1. This current I1 is determined by the level of the data signal RD1 on the data electrode DE associated with the pixel drive circuit PD1. The grey level of the LED PL2 is determined by the level of the current I2 flowing through the LED PL2. The current 12 is determined by the level of the data signal BD1 on the data electrode DE associated with the pixel drive circuit PD2.

The timing controller TC receives the synchronization signal SY associated with the input image signal IV and supplies the control signal CR to the select driver SD and the control signal CC to the data driver DD. The control signals CR and CC synchronize the operation of the select driver SD and the data driver DD such that the output signals FR, FG, FB are presented to the data electrodes DE after the associated row of pixels 10 has been selected. Usually, the timing controller TC controls the select driver SD to supply select voltages to the select electrodes (also commonly referred to as address lines) SE to select (or address) the rows of pixels 10 one by one. In practice, more address lines per display row (which is a row of pixels 10) may be used, for example to control the duty cycle of the currents I1, I2 supplied to the LED's PL1, PL2, respectively. It is possible to select more than one row of pixels 10 at a same time. The timing controller TC controls the data driver DD to supply the data signals RD1 and BD1 in parallel to the selected row of pixels 10. The effect of the low-pass filter LPF will be elucidated with respect to FIG. 3.

The display panel 1 is defined to comprise the pixels 10. In a practical embodiment, the display panel 1 may also comprise all or some of the driver circuits DD, SD and TC. This combination of driver circuits and display panel is often referred to as display module. This display module can be used in many display apparatuses, for example in television, computer display apparatuses, game consoles, or in mobile apparatuses such as PDA's (personal digital assistant) or mobile phones.

It is possible to perform the low-pass filtering on the data signals BD1. However, this has the drawback that the filtering is not performed in the light linear domain (i.e. on values directly describing the desired light output or luminance). The signals BD1 from the data driver DD are not in the light linear domain, because the pixel circuits have a non-linear transfer function. Some video scalers already work in the linear light domain, and thus can be used also for the low-pass filtering. The video scalers supply the signals FR and FB to the data driver DD. Also the high frequency boost filter HF may be repositioned to process the signals RD1 and/or GD1 instead of the signals RG and/or GG.

The data driver DD, the optional gamma circuit GA, the optional high frequency boosting filter HF, the low-pass filter LPF, and the optional de-gamma circuit DC are collectively indicated by the data processor DR.

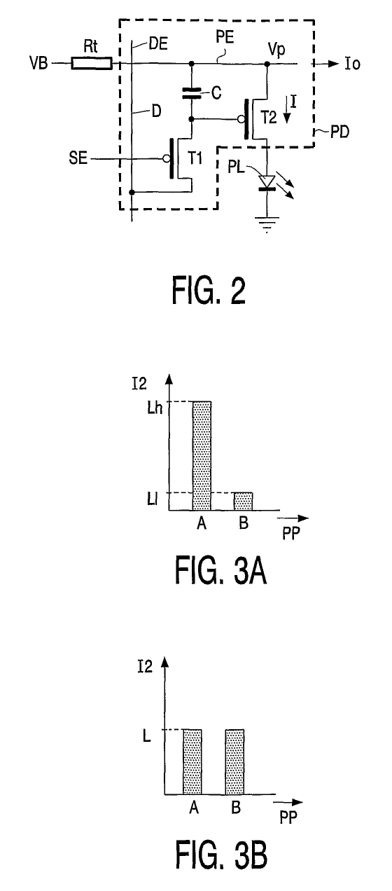

FIG. 2 shows an embodiment of a pixel drive circuit to generate a current through the light emitting elements. The pixel driving circuits PD1 and PD2, the light emitting elements PL1 and PL2, and the currents I1 and 12 shown in FIG. 1 are now collectively referred to as the pixel driving circuit PD, the LED PL, and the current I. The pixel driving circuit PD comprises a series arrangement of a main current path of a transistor T2 and the LED PL. The transistor T2 is shown to be a FET but may be any other transistor type, the LED PL is depicted as a diode but may be another current driven light emitting element. The series arrangement is arranged between the power supply electrode PE and ground (either an absolute ground or a local ground, such as a common voltage). The control electrode of the transistor T2 is connected to a junction of a capacitor C and a terminal of the main current path of the transistor T1. The other terminal of the main current path of the transistor T1 is connected to the data electrode DE, and the control electrode of the transistor T1 is connected to the select electrode SE. The transistor T1 is shown to be a FET but may be another transistor type. The still free end of the capacitor C is connected to the power supply electrode PE.

The operation of the circuit is elucidated in the now following. When a row of pixels 10 is selected by an appropriate voltage on the select electrode SE with which this row of pixels 10 is associated, the transistor T1 is conductive. The data signal D which has a level indicating the required light output of the LED PL is fed to the control electrode of the transistor T2. The transistor T2 gets an impedance in accordance with the data level, and the desired current I starts to flow through the LED PL. After the select period of the row of pixels 10, the voltage on the select electrode SE is changed such that the transistor T1 becomes a high resistance. The data voltage D which is stored on the capacitor C is kept and drives the transistor T2 to still obtain the desired current I through the LED PL. The current I will change when the select electrode SE is selected again and the data voltage D is changed.

The current I has to be supplied by the power supply electrode PE which receives the power supply voltage VB via a resistor Rt. The resistor Rt represents the resistance of the power supply electrode towards the pixel 10 shown. It has to be noted that other pixels 10 associated with the same power supply electrode PE may carry current too, this current is denoted by Io. Both the currents Id and lo flow through the resistor Rt and thus cause a voltage drop in the power supply electrode PE. The pixel driving circuit PD will only function correctly if the voltage Vp across the series arrangement of the main current path of the transistor T2 and the LED L is sufficiently high to obtain the current I.

The pixel driving circuit PD may have another construction than shown in FIG. 2. For example, some alternative pixel driving circuits PD are disclosed in the publication “A Comparison of Pixel Circuits for Active Matrix Polymer/Organic LED Displays”, D. Fish et al, SID 02 Digest, pages 968-971.

FIG. 3 shows the effect of low-pass filtering of the data signal on the current through the light emitting element PL. In both FIG. 3A and FIG. 3B, the horizontal axis represents pixel positions PP and the vertical axis represents the current I2 through the LED PL2. FIG. 3A shows the current 12 through the light emitting element PL2 if the data signal BD1 is supplied to the pixel drive circuit PD2 without low-pass filtering. It is assumed that the current I2 has a relatively high value Lh for the pixel 10 at a particular pixel position A and a relatively low value L1 at the adjacent pixel position B. FIG. 3B shows the current 12 if the low-pass filtered data signal BD1 is supplied to the drive circuit PD2. Now, in this example, on both the pixels positions A and B a same current level L is supplied to the associated pixels 10. The current level L is the average value of the current levels Lh and L1. Of course, another low-pass filtering is possible wherein the current level Lh becomes lower and the current level L1 becomes higher but not equal.

To elucidate the effect of different levels of the current 12 on the aging of the light emitting element PL2 it is assumed that, due to the changing image content, without the low-pass filtering the current 12 through a particular light emitting element PL2 has alternatively the value Lh and L1, while another light emitting element PL2 always receives the current L. Because the light emitting element PL2 ages especially fast for high current levels, the total aging caused by the currents Lh and Ll (FIG. 3A) is higher than the total aging caused by the currents L and L (FIG. 3B). This is elucidated in the now following.

The lifetime LT of polymer materials depends on the time T a luminance LU is generated by it:

LT˜LU^{-p}/T

wherein p is a power factor which depends on the material. It has to be noted that the relation between the luminance LU and the current 12 is approximately linear. With a typical power factor value of 1.6, the lifetime LT1 for the particular light emitting element PL2 driven in accordance with FIG. 3A and the lifetime LT2 for the another light emitting element PL2 driven in accordance with FIG. 3B is approximately (if L=0.5 Lh and Ll=0):

LT1˜(2*Lh^{-1,6})/T

LT2˜(3*Lh^{1,6})/T

### Thus, the pixels A and B driven as shown in FIG. 3A age much faster than the pixels A and B driven as shown in FIG. 3B.

Based on this insight, the present invention introduces the low-pass filter LPF. The low-pass filter LPF averages levels of the current 12 and thus limits the occurrence of high peak values of this current. The low-pass filtering is especially relevant if the light emitting elements PL2 age faster than the light emitting elements PL1. The lifetime of the display is increased because the light emitting elements PL2 are driven with lower peak currents.

Further, the differential aging of the light emitting elements PL2 becomes less because sharp transitions in the current 12 are smoothed and consequently no large aging difference occurs between the adjacent pixels A and B. Thus, because of the low-pass filtering, large luminance variations from pixel to pixel are decreased and the differential ageing, which is currently a large problem in OLED displays, is reduced. The reduction is obtained in displays with all types of organic LED materials (polymer as well as small molecule OLED), and also with a power factor p smaller than one. Note that also small molecule materials are known for which the power factor is larger than one. Furthermore, the differential aging can also be decreased in other displays such as inorganic electroluminescent display and plasma displays.

From the equations defining the lifetimes LT1 and LT2 it becomes clear that the lifetime LT2 is longer than the lifetime LT1 for all display panels for which holds that the power factor p is larger than 1. In OLED displays, the blue pixels have the shortest lifetime and thus the blue data signal is low-pass filtered to enlarge the lifetime of the blue pixels and thus the lifetime of the display panel. Since the human visual system can resolve less resolution in the blue part of the visible spectrum, the loss of resolution for the blue data is not or almost not perceived by viewers.

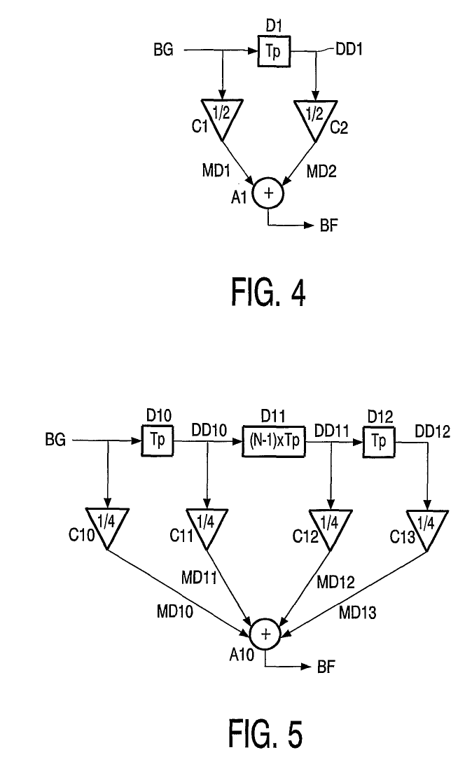

FIG. 4 shows an embodiment of the low-pass filter. The digital implementation of the low-pass filter LPF comprises a delay stage D1 which receives the corrected signal BG and supplies a delayed signal DD1 which is the corrected signal BG delayed over a pixel period Tp. Usually, the pixel period Tp has a duration which is the ratio of the number of pixels 10 in a row and the row select time. A multiplier C1 multiplies the corrected signal BG with a factor ½ to obtain the multiplied signal MD1. The multiplier C2 multiplies the delayed data signal DD1 with a factor ½ to obtain the multiplied signal MD2. The summing circuit A1 sums the multiplied signals MD1 and MD2 to obtain the low-pass filtered input image signal BF. The multipliers C1 and C2 are in fact bit shifters. However, if other multiplying factors C1 and C2 are used which are not a power of 2, it is not possible to use simple bit shifters. This low-pass filter LPF determines for each pixel 10 a level of the low-pass filtered input image signal BF which is the sum of half the level of the corrected signal BG of the previous pixel (thus the value of DD1) and half the level of the corrected signal BG of the present pixel.

FIG. 5 shows another embodiment of the low-pass filter. This digital implementation of the low-pass filter comprises a delay stage D10 which receives the corrected signal BG and supplies a delayed data signal DD10 which is the corrected signal BG delayed over the pixel period Tp. A delay stage D1 receives the delayed data signal DD10 and supplies the delayed data signal DD11 which is the delayed data signal DD10 delayed over N−1 pixel periods Tp, wherein N is the number of pixels 10 in one row. A delay stage D12 receives the delayed data signal DD11 and supplies the delayed data signal DD12 which is the delayed date signal DD11 delayed over the pixel period Tp. A multiplier C10 multiplies the corrected signal BG with a factor ¼ to obtain the multiplied signal MD10. The multiplier C11 multiplies the delayed data signal DD10 with a factor ¼ to obtain the multiplied signal MD11. The multiplier C12 multiplies the delayed data signal DD11 with a factor ¼ to obtain the multiplied signal MD12. The multiplier C13 multiplies the delayed data signal DD12 with a factor ¼ to obtain the multiplied signal MD13. The summing circuit A10 sums the multiplied signals MD10 to MD13 to obtain the low-pass filtered input image signal BF. Again, the multipliers C10 to C13 are in fact bit shifters.

This low-pass filter determines for each pixel a level of the low-pass filtered input image signal BF which is the sum of one quarter the level of the corrected signal BG of the previous pixel, one quarter the level of the corrected signal BG of the adjacent pixel of the previous pixel, one line earlier, one quarter of the level of the corrected signal BG of the adjacent pixel of the present pixel, one line earlier, and one quarter of the level of the corrected signal BG of the present pixel.

Alternatively, in another preferred embodiment the multipliers C10 to C13 may multiply with the factors ½, ⅙, ⅙, and ⅙, respectively. However many other selections of coefficients may provide useful low-pass filter characteristics.

It should be noted that the above-mentioned embodiments illustrate rather than limit the invention, and that those skilled in the art will be able to design many alternative embodiments without departing from the scope of the appended claims.

For example, many more low-pass filters than the embodiments elucidated with respect to FIGS. 4 and 5 are possible. A few more embodiments of multiplier coefficients are given in table 1 which can be found at the end of this description. Table 1 shows the filter coefficients used in experiments. The left most column indicates the number of the filter, the next column indicates the total weight of the coefficients and thus is the factor by which each one of the coefficients has to be divided. The top row indicates the coefficients C's with an index which refers to the associated pixel positions. Co is the position of the present pixel of which the average value has to be determined, C−1 is the coefficient with which the level of the pixel immediately preceding the present pixel (in the same row) has to be multiplied, C1 is the coefficient with which the level of the pixel immediately succeeding (in the same row) the present pixel has to be multiplied, and so on. The same coefficients may be used in the vertical direction if two dimensional spatial low-pass filtering is applied. Experienced viewers did not detect any resolution loss or only a negligible resolution loss of the test images displayed on the PLED display when the filters 1 to 6 were used on the blue data signals.

Alternatively, analog low-pass filters may be used. The invention can also be applied in other displays wherein ageing effects occur, such as for example, inorganic electroluminescent displays or plasma displays.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage. Table 1, Filter coefficients used in experiments.

| filter | weight | c₋₁₇ | c₋₁₆ | c₋₁₅ | c₋₁₄ | c₋₁₃ | c₋₁₂ | c₋₁₁ | c₋₁₀ | c₋₉ | c₋₈ | c₋₇ | c₋₆ |
|---|---|---|---|---|---|---|---|---|---|---|---|---|---|
| 1 | 1022 | | | | | | | | | | | | |
| 2 | 1322 | | | | | | | | | | | | |
| 3 | 1708 | | | | | | | | | | | | |
| 4 | 2204 | | | | | | | | | | | | 5 |
| 5 | 2852 | | | | | | | | | | 4 | 11 | 0 |
| 6 | 3676 | | | | | | | | 5 | 11 | 5 | −27 | −76 |
| 7 | 4748 | | | | | 5 | 10 | 10 | 0 | −28 | −67 | −96 | −84 |
| 8 | 6138 | 4 | 8 | 11 | 10 | 1 | −18 | −46 | −76 | −96 | −91 | −43 | 56 |

| filter | c₋₅ | c₋₄ | c₋₃ | c₋₂ | c₋₁ | c₀ | c₁ | c₂ | c₃ | c₄ | c₅ | c₆ |
|---|---|---|---|---|---|---|---|---|---|---|---|---|
| 1 | | | | −18 | 57 | 944 | 57 | −18 | | | | |
| 2 | | | 9 | −92 | 272 | 944 | 272 | −92 | 9 | | | |
| 3 | | 11 | −52 | −56 | 479 | 944 | 479 | −56 | −52 | 11 | | |
| 4 | 9 | −42 | −97 | 116 | 639 | 944 | 639 | 116 | −97 | −42 | 9 | |
| 5 | −53 | −98 | 3 | 335 | 752 | 944 | 752 | 335 | 3 | −98 | −53 | |
| 6 | −97 | −17 | 206 | 531 | 825 | 944 | 825 | 531 | 206 | −17 | −97 | [symbol] |
| 7 | 4 | 178 | 422 | 677 | 871 | 944 | 871 | 677 | 422 | 178 | 4 | [symbol] |
| 8 | 207 | 396 | 598 | 776 | 900 | 944 | 900 | 776 | 598 | 396 | 207 | |

[symbol]

indicates data missing or illegible when filed

1. A driver (DR, SD, PD1, PD2) for a display panel comprising a first set of light emitting elements (PL1) and a second set of light emitting elements (PL2), the driver (DR, SD, PD1, PD2) comprises:
a data processor (DR) for receiving a first set of input image signals (R) representing a first color to supply a first set of data signals (RD1) to the first set of light emitting elements (PL1), respectively, and for receiving a second set of input image signals (B) representing a second color to supply a second set of data signals (BD1) to the second set of light emitting elements (PL2), respectively, and
a low-pass filter (LPF) for obtaining the second set of data signals (BD1) having a bandwidth being smaller than a bandwidth of the first set of data signals (RD1).

2. A driver (DR, SD, PD1, PD2) as claimed in claim 1, wherein the driver (DR, SD, PD1, PD2) further comprises:
a first set of pixel drivers (PD1) for receiving the first set of data signals (RD1) to supply a first set of currents (I1) to the first set of light emitting elements (PL1), respectively, and
a second set of pixel drivers (PD2) for receiving the second set of data signals (BD1) to supply a second set of currents (12) to the second set of light emitting elements (PL2), respectively, wherein
the data processor (DR) comprises a data driver (DD) for supplying the data signals (BD1), and wherein the low-pass filter (LPF) is arranged for receiving the second set of input image signals (B) to supply a set of low-pass filtered image signals (FB) to the data driver (DD).

3. A driver as claimed in claim 1, wherein the low-pass filter (LPF) comprises a spatial low-pass filter.

4. A driver as claimed in claim 3, wherein the low-pass filter (LPF) comprises a two-dimensional spatial low-pass filter.

5. A driver as claimed in claim 1, wherein the low-pass filter (LPF) comprises a temporal low-pass filter.

6. A driver as claimed in claim 1, wherein the first light emitting elements (PL1) and the second light emitting elements (PL2) are organic light emitting diodes.

7. A driver as claimed in claim 5, wherein the first light emitting element (PL1) is arranged for emitting red light (R), and wherein the second light emitting element (PL2) is arranged for emitting blue light (B).

8. A driver as claimed in claim 1, further comprising a high frequency boosting filter (HPF) for obtaining the first set of data signals (RD1) being high-frequency boosted.

9. A display module comprising the display panel (1) having pixels (10) with light emitting elements (PL1, PL2), and the driver (DR, SD, PD1, PD2) as claimed in claim 1.

10. A display apparatus comprising the display module as claimed in claim 9.

11. A display apparatus as claimed in claim 10, wherein the display panel (1) is an active matrix electroluminescent display panel (1).

12. A method of driving (DR, SD, PD1,PD2) a display panel comprising a first set of light emitting elements (PL1) and a second set of light emitting elements (PL2), the method (DR, SD, PD1, PD2) comprises:
receiving (DR) a first set of input image signals (R) representing a first color to supply a first set of data signals (RD1) to the first set of light emitting elements (PL1), respectively,
receiving (DR) a second set of input image signals (B) representing a second color to supply a second set of data signals (BD1) to the second set of light emitting elements (PL2), respectively, and
low-pass filtering (LPF) for obtaining the second set of data signals (BD1) having a bandwidth being smaller than a bandwidth of the first set of data signals (RD1).
